(19) United States
(12) Patent Application Publication
(10) Pub. No.: US 2013/0151172 A1
(43) Pub. Date: Jun. 13, 2013

(54) METHOD AND DEVICE FOR DETERMINING A COMPARATIVE MOISTURE LEVEL

(71) Applicants: Pydisetty Nageswara Rao, Hyderabad (IN); Christopher Ranwell, Andover, MA (US)

(72) Inventors: Pydisetty Nageswara Rao, Hyderabad (IN); Christopher Ranwell, Andover, MA (US)

(73) Assignee: General Electric Company, Schenectady, NY (US)

(21) Appl. No.: 13/323,369

(22) Filed: Dec. 12, 2011

(51) Int. Cl. G01N 5/02; G06F 19/00

(52) U.S. Cl. 702/50; 73/73

(57) ABSTRACT

A method and device for providing a comparative moisture level of an material are disclosed. The method and device provide a comparative moisture level of a test moisture level of a test material compared to a reference moisture level of a reference material, indicating whether the test moisture level of the test material is less than (dryer), equal to, or greater than (wetter) than the reference moisture level of the reference material.

### BACKGROUND OF THE INVENTION

The subject matter disclosed herein relates to measuring moisture levels and, more particularly, to determining comparative moisture levels.

Moisture meters can be used to measure and display the moisture level of a variety of building materials, including wood, drywall, concrete, plaster, etc., within building structures (e.g., walls, floors, etc.). The moisture meter can be calibrated based on the particular materials to be measured to indicate actual moisture content by percentage weight or the wood moisture equivalent in order to establish whether the material is dry, damp, or wet. For example, the moisture meter can include a digital display showing the moisture level of the material based on a numerical scale and/or a visual colored scale (e.g., green (dry—safe), yellow (damp—risk), and red (wet—critical)).

In some applications, where the normal moisture level of a material may not be known, it is useful to make comparative moisture level measurements between materials that are known to be relatively dry (e.g., walls and floors in an unflooded portion of a flooded house) and those materials that are suspected to be relatively wet (e.g., walls and floors in the flooded portion of a flooded house). In an exemplary comparative moisture level measurement, an inspector can measure and manually record on a piece of paper the reference moisture level of the material known to be dry and then measure the test moisture level of the test material suspected of being wet. The two moisture level measurements can then be manually compared to determine the comparative moisture level measurement. Having to manually record and compare the reference moisture level to perform a comparative moisture level measurement can slow down an inspection or lead to inaccurate comparative moisture level measurements.

The discussion above is merely provided for general background information and is not intended to be used as an aid in determining the scope of the claimed subject matter.

### BRIEF DESCRIPTION OF THE INVENTION

A method and device for providing a comparative moisture level of a material is disclosed. The method and device provide a comparative moisture level of a test moisture level of a test material compared to a reference moisture level of a reference material, indicating whether the test moisture level of the test material is less than (dryer), equal to, or greater than (wetter) than the reference moisture level of the reference material. An advantage that may be realized in the practice of some disclosed embodiments is that the comparative moisture level can more quickly and easily provide information regarding the moisture levels of the test material and the reference material.

In one embodiment, a method and device for determining a comparative moisture level with a moisture meter are disclosed. The comparative moisture level is determined by measuring the reference moisture level of a reference material by performing a moisture level measurement with the moisture meter, storing on the moisture meter the reference moisture level, measuring the test moisture level of a test material by performing a moisture level measurement with a moisture meter, determining on the moisture meter the comparative moisture level of the test material by comparing the reference moisture level from the test moisture level, and displaying on the moisture meter the comparative moisture level.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is an exemplary moisture meter;

FIG. 2 is a flow diagram of an exemplary method for determining a comparative moisture level with a moisture meter; and

FIGS. 3 through 7 show exemplary displays of the moisture meter of FIG. 1 at different steps in the method of FIG. 2.

### DETAILED DESCRIPTION OF THE INVENTION

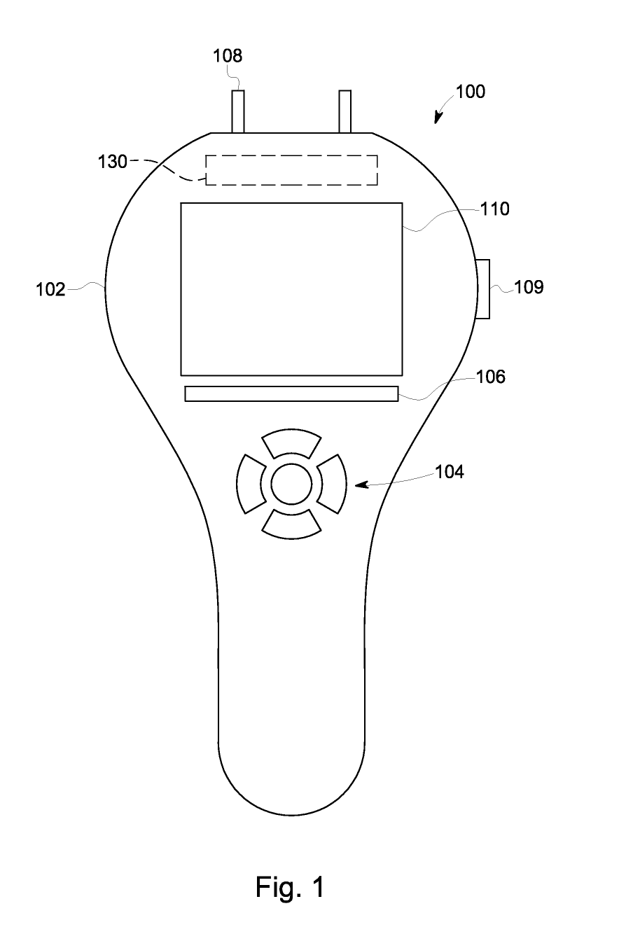

FIG. 1 is an exemplary moisture meter 100, which can include a display 110 and a housing 102. The moisture meter 100 can have a processor, memory, and executable instructions that are stored on the memory or available to be executed by the processor (e.g., downloadable from a network). These executable instructions can make up all or a portion of the software and software packages discussed herein. As will be explained, the display 110 can display a number of different pieces of information to an inspector when performing moisture level measurements, including the selected moisture measurement mode (e.g., non-invasive, invasive, etc.), measured and/or or comparative moisture levels, material moisture level status (dry, damp, wet), remaining battery life, etc. As shown, the exemplary moisture meter 100 can operate in both non-invasive (or pinless) and invasive (or pin-type) moisture measurement mode. The information on the display 110 can result from execution of the software and executable instructions, which can be stored in memory and configured to be executed by one or more processors. Variations in the configuration of the display 110 may occur in response to inputs by an inspector. The moisture meter 100 can also include input keys 104 allowing an inspector to scroll through options and make selections on the display 110 of the moisture meter 100.

For operating in non-invasive moisture measurement mode (or pinless mode), the moisture meter 100 uses a conductive method (e.g., transmitting an RF signal) to electrically penetrate into the test material without physically penetrating the surface of the material. In one embodiment, a probe 130 located within the housing 102 of the moisture meter 100 can transmit into and receive signals from the test material. Moisture level measurements beneath the surface of the test material in non-invasive mode can be provided based on a relative scale from, e.g., 0 to 1,000. The non-invasive moisture level measurements determine the moisture level in relative terms rather than actual moisture content readings. For example, in one embodiment, a moisture level of less than or equal to a first moisture level threshold (e.g., 160) can be considered dry, while a moisture level reading of greater than a second moisture level threshold (e.g., 200) can be considered wet, with a reading between the first and second moisture level thresholds considered damp. It will be understood that scales of measurement may vary from meter to meter.

For operating in invasive moisture measurement mode (or pin-type mode), the moisture meter has conductive probes 108 at least a portion of which are outside of the housing 102 that physically penetrate the surface of the test material. The moisture meter 100 also can include an adaptor 109 for connecting external conductive probes if measurements within the test material are required at deeper levels than the integral conductive probes 108 can penetrate. Moisture level measurements inside the material (e.g., inside a floor or wall) between the conductive probes 108 in invasive mode can be provided based on a percent moisture content from, e.g., 6% to 100%, relative to the percent moisture content in wood (or wood moisture equivalent (WME)). Invasive moisture level measurements conducted in wood are actual percent moisture content, whereas invasive moisture level measurements in materials other than wood are equivalent percent moisture content that wood be attained by wood in moisture equilibrium with the test material. Since the critical percent moisture content is known, these equivalent percent moisture content values can be used to establish if the test material is, e.g., dry (less than or equal to 16.0%), damp (between 16.1% and 20%), or wet (greater than 20.0%).

In one embodiment, the moisture meter 100 can include an indicator bar 106 that can provide a color coding for each of the possible moisture levels (dry (green), damp (yellow), or wet (red)). In one embodiment, the indicator bar 106 can comprise LEDs for the different color codings, while in another embodiment, an indicator bar may be incorporated into the display 110.

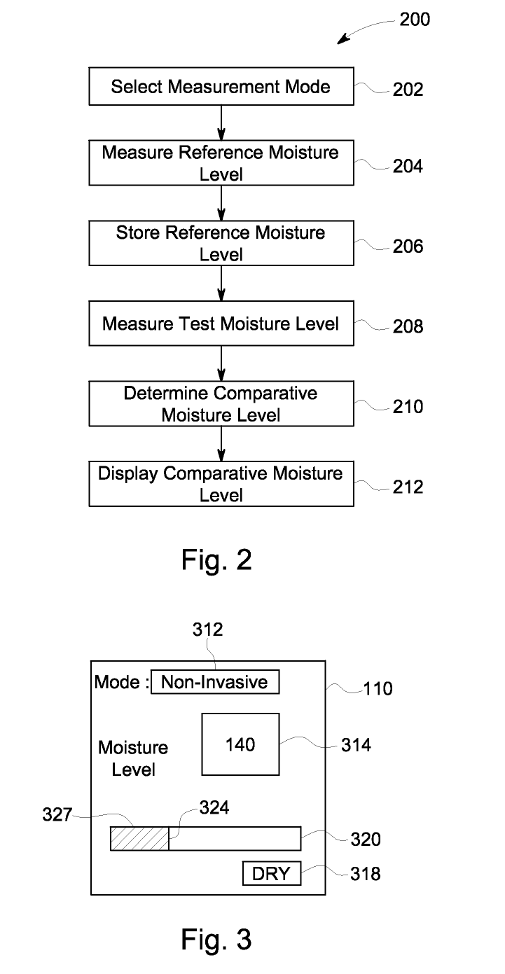

FIG. 2 is a flow diagram of an exemplary method 200 for determining a comparative moisture level with a moisture meter 100. FIGS. 3 through 7 show the display 110 of the moisture meter 100 of FIG. 1 at different steps in the method 200 of FIG. 2. At step 202, an inspector can select the type of moisture measurement mode for the moisture meter 100 (e.g., non-invasive or invasive). In one embodiment, an inspector can use the input keys 104 to select the moisture measurement mode. It will be understood that this step 202 may not be required for moisture meters that perform only one type of measurement. As shown in FIGS. 3 through 7, in this exemplary illustration, the non-invasive moisture measurement mode is selected and displayed in the measurement mode field 312 of the display 110 on the moisture meter 100. It will be understood that the exemplary method can also be used with other moisture measurement modes (e.g., invasive).

At step 204, an inspector can measure the reference moisture level of a reference material by performing a moisture level measurement with the moisture meter 100. The moisture level measurement can be performed using non-invasive or non-invasive techniques. As shown in FIG. 3, this reference moisture level (e.g., 140) can be displayed on the moisture meter 100 in the moisture level field 314 on the display 110. Assuming for illustrative purposes that a moisture level of less than or equal to a first moisture threshold (e.g., 160) can be considered dry, while a moisture level reading of greater than a second moisture level threshold (e.g., 200) can be considered wet, with a reading between the first and second moisture level thresholds considered damp, the measured reference moisture level for the reference material is displayed on the moisture meter 100 as “DRY” in the material moisture level status field 318 as shown in FIG. 3. The indicator bar 320 on the display 110 of the moisture meter 100 provides a graphical indication of the measured moisture level 324 of the reference material as well as the color coding (e.g., green) 327 for a dry moisture level status. It will be understood that the moisture level could also indicate actual moisture content by percentage weight or the wood moisture equivalent if performing measurements in invasive mode.

At step 206, the reference moisture level can be stored in the memory of the moisture meter 100 for later use in providing a comparative moisture level. In one embodiment, an inspector can select one of the input keys 104 to store the reference moisture level.

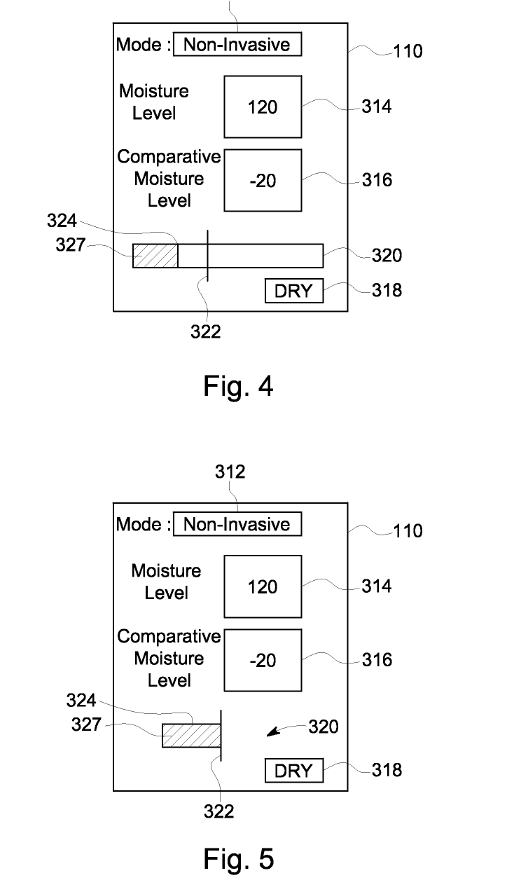

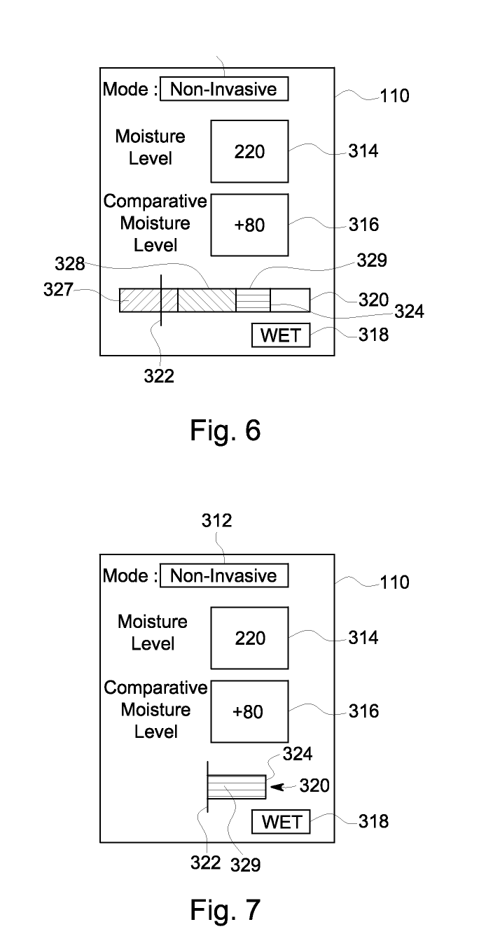

At step 208, an inspector can measure the test moisture level of a test material by performing a moisture level measurement with the moisture meter 100. As shown in FIGS. 4 through 7, this test moisture level can be displayed on the moisture meter 100 in the moisture level field 314 on the display 110. In the example shown in FIGS. 4 and 5, the test moisture level (e.g., 120) can be displayed on the moisture meter 100 in the moisture level field 314 on the display 110. The moisture level status of the reference material test is displayed on the moisture meter 100 as “DRY” in the material moisture level status field 318. In another example shown in FIGS. 6 and 7, the test moisture level (e.g., 220) can be displayed on the moisture meter 100 in the moisture level field 314 on the display 110. The moisture level status of the test material is displayed on the moisture meter 100 as “WET” in the material moisture level status field 318.

At step 210, the moisture meter 100 can determine the comparative moisture level of the test material by comparing the reference moisture level to the test moisture level. For example, the comparative moisture level of the test material can be determined by subtracting the reference moisture level from the test moisture level. As shown in FIGS. 4 through 7, at step 212, this comparative moisture level can be displayed on the moisture meter 100 in the comparative moisture level field 116 of the display 110. As shown in FIGS. 4 and 5, if the test moisture level (e.g., 120) is lower than the measured moisture level of the reference material (e.g., 140), then the comparative moisture level would be a negative number (e.g., −20) indicating that the test material is dryer than the reference material. Similarly, as shown in FIGS. 6 and 7, if test moisture level (e.g., 220) is higher than measured moisture level of the reference material (e.g., 140), then the comparative moisture level would be a positive number (e.g., +80) indicating that the test material is wetter than the reference material.

As shown in FIGS. 4 through 7, the indicator bar 320 on the display 110 of the moisture meter 100 can provide a graphical indication of the test moisture level 324 as well as the color coding (e.g., green (dry) 327, yellow (damp) 328, red (wet) 329) for the moisture level status of the test material. The indicator bar 320 also provides a graphical indication of the reference moisture level 322 for visual comparison to the graphical indication of the test moisture level 324. It will be understood that different configurations of indicator bars 320 can be used to display the comparative moisture level.

In one embodiment, as shown in FIGS. 4 and 6, the indicator bar 320 on the display 110 of the moisture meter 100 locates the reference moisture level 322 and the test moisture level 324 on a continuum of the color coding spectrum of the moisture level status of the test material. For example, FIG. 4 shows the indicator bar 320 for a reference moisture level 322 of 140, a test moisture level 324 of 120, and a comparative moisture level 316 of −20, showing that the test moisture level 324 is lower than the reference moisture level 322 (i.e., test material is more dry than the reference material). Since the test moisture level 324 is dry, the color coding of the indicator bar 320 only shows green 327 for a dry moisture level status. FIG. 6 shows the indicator bar 320 for a reference moisture level 322 of 140, a test moisture level 324 of 220, and a comparative moisture level 316 of +80, showing that the test moisture level 324 is higher than the reference moisture level 322 (i.e., test material is more wet than the reference material). Since the test moisture level 324 of 220 is wet, the color coding of the indicator bar 320 shows a color coding (e.g., red) 329 for a wet moisture level status. The indicator bar 320 can also show that the color coding for dry (green) 327 and damp (yellow) 328 had been exceeded by the measured test moisture level.

In one embodiment, as shown in FIGS. 5 and 7, the indicator bar 320 provides the positions of the reference moisture level 322 and the test moisture level 324 relative to each other. For example, FIG. 5 shows the indicator bar 320 for a reference moisture level 322 of 140 located centrally, a test moisture level 324 of 120, and a comparative moisture level 316 of −20. The indicator bar 320 extends in the left (or negative) direction for a length proportionate to the comparative moisture level showing that the test moisture level 324 is lower than the reference moisture level 322 (i.e., test material is more dry than the reference material). Since the test moisture level 324 of 120 is dry, the color coding of the indicator bar 320 only shows green 327 for a dry moisture level status. FIG. 7 shows the indicator bar 320 for a reference moisture level 322 of 140, a test moisture level 324 of 220, and a comparative moisture level 316 of +80. The indicator bar 320 extends in the right (or positive) direction for a length proportionate to the comparative moisture level showing that the test moisture level 324 is higher than the reference moisture level 322 (i.e., test material is more wet than the reference material). Since the test moisture level 324 of 220 is wet, the color coding of the indicator bar 320 shows a color coding (e.g., red) 329 for a wet moisture level status.

In view of the foregoing, embodiments of the devices and methods provide comparative moisture levels to an inspector that is performing an inspection. A technical effect is to improve the inspection process by more quickly and easily provide information regarding the moisture levels of the test object and the reference object.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “module,” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code and/or executable instructions embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A device for determining a comparative moisture level comprising:
a housing;
a display;
an input key;
a probe to determine the reference moisture level of a reference material and the test moisture level of a test material;
a processor;
memory coupled to the processor; and
one or more executable instructions stored on the memory and configured to be executed by the processor, the executable instructions including instructions for
storing in the memory the reference moisture level in response to selection of the input key;
determining the comparative moisture level of the test material by comparing the reference moisture level to the test moisture level; and
displaying on the display the comparative moisture level.

2. The device of claim 1, further comprising instructions for displaying on the display the reference moisture level.

3. The device of claim 1, further comprising instructions for displaying on the display the test moisture level.

4. The device of claim 1, further comprising instructions for determining the moisture level status of the reference material by comparing the test moisture level to a moisture level threshold.

5. The device of claim 4, further comprising instructions for displaying the moisture level status of the test material on the display.

6. The device of claim 4, further comprising instructions for displaying an indicator bar on the display, wherein the indicator bar on the display is colored based on the moisture level status of the reference material.

7. The device of claim 6, wherein the length of the indicator bar is proportionate to the comparative moisture level.

8. The device of claim 1, further comprising instructions for displaying an indicator bar on the display, wherein the indicator bar comprises a graphical indication of the positions of the reference moisture level and the test moisture level relative to each other.

9. The device of claim 8, wherein the length of the indicator bar is proportionate to the comparative moisture level.

10. The device of claim 1, wherein the probe is located within the housing.

11. The method of claim 1, wherein at least a portion of the probe is located outside of the housing.

12. A method for determining a comparative moisture level with a moisture meter comprising the steps of:
measuring the reference moisture level of a reference material by performing a moisture level measurement with the moisture meter;
storing on the moisture meter the reference moisture level;
measuring the test moisture level of a test material by performing a moisture level measurement with the moisture meter;
determining on the moisture meter the comparative moisture level of the test material by comparing the reference moisture level to the test moisture level; and
displaying on the moisture meter the comparative moisture level.

13. The method of claim 1, further comprising the step of selecting a moisture measurement mode.

14. The method of claim 1, further comprising the step of displaying on the moisture meter the reference moisture level.

15. The method of claim 1, further comprising the step of displaying on the moisture meter the test moisture level.

16. The method of claim 1, further comprising the step of determining the moisture level status of the reference material by comparing the test moisture level to a moisture level threshold.

17. The method of claim 5, further comprising the step of displaying the moisture level status of the test material on the moisture meter.

18. The method of claim 5, further comprising the step of displaying an indicator bar on the moisture meter, wherein the indicator bar is colored based on the moisture level status of the reference material.

19. The method of claim 7, wherein the length of the indicator bar is proportionate to the comparative moisture level.

20. The method of claim 1, further comprising the step of displaying an indicator bar on the moisture meter, wherein the indicator bar comprises a graphical indication of the positions of the reference moisture level and the test moisture level relative to each other.
